(19) United States
(12) Patent Application Publication
(10) Pub. No.: US 2003/0197931 A1
(43) Pub. Date: Oct. 23, 2003

(54) Viewing apparatus

(75) Inventor: Takaaki Yano, Hokkaido (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/403,087

(22) Filed: Apr. 1, 2003

(30) Foreign Application Priority Data
Apr. 23, 2002 (JP) 2002-120708

(51) Int. Cl. G02B 1/00; G03B 13/02; G02B 23/00

(52) U.S. Cl. 359/431; 359/362; 359/422; 359/432; 396/373

(57) ABSTRACT

A viewing apparatus in which an object image formed by an objective lens system is viewed through an eyepiece system includes a beam splitter which is located closer to an object than a focal plane of the objective lens system in a light path of the objective lens system, a negative lens provided in an optical path of light split by the beam splitter, and a photographing optical system attachment/detachment portion provided on a light emission side of the negative lens.

### BACKGROUND OF THE INVENTION

1. Field of the Invention

The present invention relates to a viewing apparatus for use with an optical viewing apparatus, such as a binocular, a telescope or a spotting-scope, in which an image of an object which can be viewed by a viewer's eye(s) can be photographed or captured as an image by a camera.

2. Description of the Related Art

In a known optical viewing apparatus, such as a binocular, a telescope or a spotting-scope, a photographing device such as a silver-halide camera or an electronic camera, capable of collimating, is mounted behind an eyepiece (on the eye side) to photograph or capture an image of an object.

However, in such a known photographing device, since a photographing operation is carried out via an eyepiece, it is impossible to photograph an object while viewing the object with the naked eye. In particular, it is difficult to view the object with the naked eye and take a picture at the same time, while holding the viewing device by hand without mounting the viewing device to a tripod.

Moreover, assuming that a viewer is holding binoculars by hand outdoors, if a third person wants to describe an object within the field of view of the binoculars to the viewer, particularly to a child viewer who may not be familiar with the operation of the binoculars, it would be difficult for the third person to make the viewer understand the object because the third person cannot correctly determine the field of view of the viewer's binoculars.

### SUMMARY OF THE INVENTION

The present invention eliminates the drawbacks of the prior art mentioned above by providing a viewing apparatus for a viewing device such as a binocular, a telescope or spotting-scope, in which an object can be viewed by viewer's eyes and an object image can be photographed by a camera.

According to an aspect of the present invention, a viewing apparatus in which an object image formed by an objective optical system is viewed through an ocular optical system, including a beam splitting optical system which is located closer to an object than a focal plane of the objective optical system in a light path of the objective optical system; a negative lens provided in an optical path of light split by the beam splitting optical system; and a photographing optical system attachment/detachment portion provided on a light emission side of the negative lens.

It is desirable for an electronic camera which can photograph the object image formed through the objective optical system and the negative lens to be detachably attached at a front end of a photographing lens thereof to the photographing optical system attachment/detachment portion.

It is desirable for the focal length and the position of the negative lens provided in the optical path of the split light to be determined so that the axial rays of light emitted from the negative lens substantially become parallel rays or divergent rays of light.

The beam splitting optical system can be a half mirror or a prism.

It is desirable for the beam splitting optical system to include a stationary half mirror provided in the light path of the objective optical system.

The beam splitting optical system can be movable between a retracted position out of the light path of the objective optical system and a photographing position in the light path of the objective optical system.

The beam splitting optical system can be a total reflection mirror that is movable between a retracted position out of the light path of the objective optical system and a photographing position in the light path of the objective optical system.

In another embodiment, a viewing apparatus in which an object image formed by an objective optical system is viewed through an ocular optical system is provided, including a beam splitting optical system which is located closer to an object than a focal plane of the objective optical system in a light path of the objective optical system, an optical element provided in an optical path of light split by the beam splitting optical system, and a photographing optical system attachment/detachment portion provided on a light emission side of the optical element. The optical element causes the axial rays of light emitted from the optical element to be one of substantially parallel rays and divergent rays.

The optical element can be a single negative lens element.

The optical element can include a plurality of lens elements and the photographing lens.

The negative lens can include a negative meniscus lens and a cemented negative lens.

The negative lens can be a cemented negative lens.

The present disclosure relates to subject matter contained in Japanese Patent Application No. 2002-120708 (filed on Apr. 23, 2002) which is expressly incorporated herein by reference in its entirety.

### BRIEF DESCRIPTION OF THE DRAWINGS

The present invention will be discussed below with reference to the accompanying drawings, in which:

FIG. 1 is a side view of one of a pair of telescopes which constitute a binocular, according to a first embodiment of the present invention;

FIG. 2 is a side view of one of a pair of telescopes of a binocular, according to a second embodiment of the present invention;

FIG. 3 is a side view of one of a pair of telescopes of a binocular, according to a third embodiment of the present invention; and

FIG. 4 is a side view of one of a pair of telescopes of a binocular, according to a fourth embodiment of the present invention.

### DESCRIPTION OF THE PREFERRED EMBODIMENT

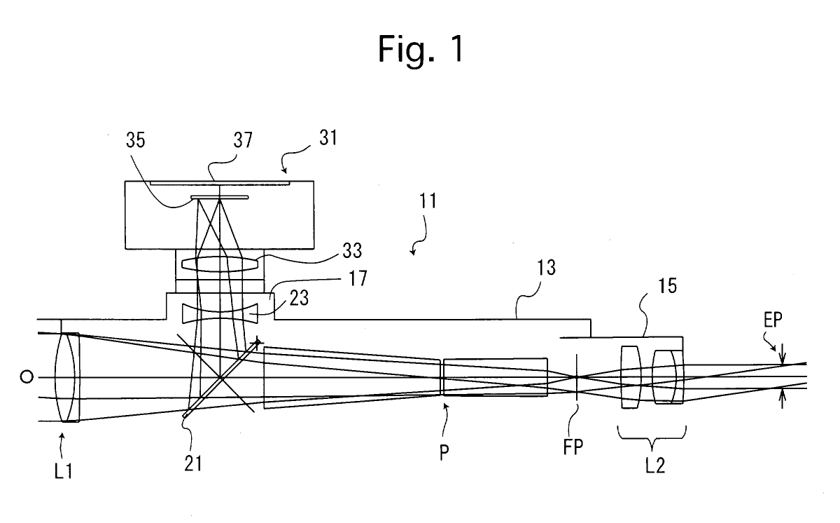

In FIG. 1, which shows one of a pair of telescopes constituting a binocular, the telescope 11 comprises an objective lens group L1 which constitutes an objective optical system, and an ocular lens group (ocular optical system) L2 which constitutes an eyepiece optical system, arranged in that order from the field side. A half mirror (beam splitting optical system) 21 which constitutes a beam splitter is provided between the objective lens group L1 and an image erecting prism P. Light incident upon the objective lens group L1 from the field is converged by the objective lens group L1. The light is partly transmitted through the half mirror 21 and is reflected by the image erecting prism P so as to form a real erect image on an image forming surface FP. The erect image formed on the image forming surface FP is enlarged and can be viewed through the ocular lens group L2. Note that in the telescope 11 of the illustrated embodiment, the ocular lens group L2 is attached to an eyepiece barrel 15 which is movable in the optical axis direction relative to an objective lens barrel 13 to which the objective lens group L1 and the prism P are mounted. Focusing is carried out by moving the eyepiece barrel 15 in the optical axis direction. In the drawings, EP represents the exit pupil.

The optical path of the light reflected by the half mirror 21 is provided therein with a negative lens (optical element) 23. The light emitted from the negative lens 23 is emitted from a camera attachment/detachment opening 17 which is formed in the objective lens barrel 13 to define a photographing optical system attachment/detachment portion. As a photographing optical system, an electronic camera such as a digital still camera 31 can be detachably attached to the camera attachment/detachment opening 17.

The light emitted from the camera attachment/detachment opening 17 is made incident upon a photographing lens 33 of the digital still camera 31 attached to the camera attachment/detachment opening 17, so that an object image is formed on an image pickup device 35. The digital still camera 31 is provided on its main body with a liquid crystal display (LCD) 37 so that the object image formed on the image pickup device 35 is picked up and displayed in the LCD 37. Namely, an object image in the field of view, substantially corresponding to the object image in the field of view which can be viewed through the ocular lens group L2 is displayed in the LCD 37.

The negative lens 23 defines an optical element which substantially makes the axial light rays emitted from the negative lens 23 parallel rays or divergent rays to form an object image on the image pickup device 35 through the photographing lens 33.

When a viewer who holds the binoculars with his or her hands uses the binoculars in the field, even if the viewer is a child who is not familiar with the operation of the binoculars, a third person can correctly explain the object within the field of view of the binoculars, to the viewer, while looking at an image of the object picked up by the digital still camera 31 and displayed in the liquid crystal display 37. Note that the LCD 37 may be a display provided separate from the digital still camera 31.

The camera attachment/detachment opening 17 is formed so that a camera, such as the digital still camera 31 can be detachably attached thereto. For example, to detachably attach the digital still camera 31 directly to the camera attachment/detachment opening 17, it is possible to use a male-female screw structure in which an external thread is formed on the camera attachment/detachment opening portion and an internal thread is formed on a front end of a lens barrel of the digital still camera, so that the external thread is inserted in and engaged by the internal thread, or a sleeve structure in which the front end of the lens barrel is fitted in the camera attachment/detachment opening 17. Alternatively, it is possible to use an attachment to connect the camera attachment/detachment opening 17 and the lens barrel of the camera. It is desirable that the camera attachment/detachment opening 17 be provided with a glass cover or the like to seal the lens barrel. Also, it is desirable that the camera attachment/detachment opening 17 be closed by a cap or the like to intercept light when no camera is attached to the camera attachment/detachment opening 17. The camera includes an electronic camera, such as a video camera or a CCD camera.

When the present invention is applied to a binocular, both telescopes of the binocular can be constructed as shown in FIG. 1. Consequently, the structures of the lens barrels are identical to each other, so that a user can attach the camera to any convenient one of the lens barrels.

The negative lens 23 is an auxiliary lens (or a collimating lens) which is adapted to focus on an image of the object formed on the image pickup device of the digital still camera 31 through the objective lens group L1. The negative lens 23 is set so that the axial rays of light emitted therefrom substantially become parallel rays or divergent rays. Since the object to be viewed by the telescope 11 is usually located far away, the absolute value of the power of the negative lens 23 is equal to or slightly greater than the absolute value of the power of the objective lens group L1. Consequently, the digital camera is focused on infinity or at a far distance.

The insertion of the negative lens 23 contributes to reduction of the Petzval sum of the optical system to thereby make it possible to compensate for curvature of field. Since the aberrations are corrected by a combination of the objective lens system, the image erecting optical system and the ocular optical system, in a viewing system such as a binocular, aberrations cannot be sufficiently corrected by only the objective lens system. Therefore, the negative lens 23 makes it possible to compensate aberrations.

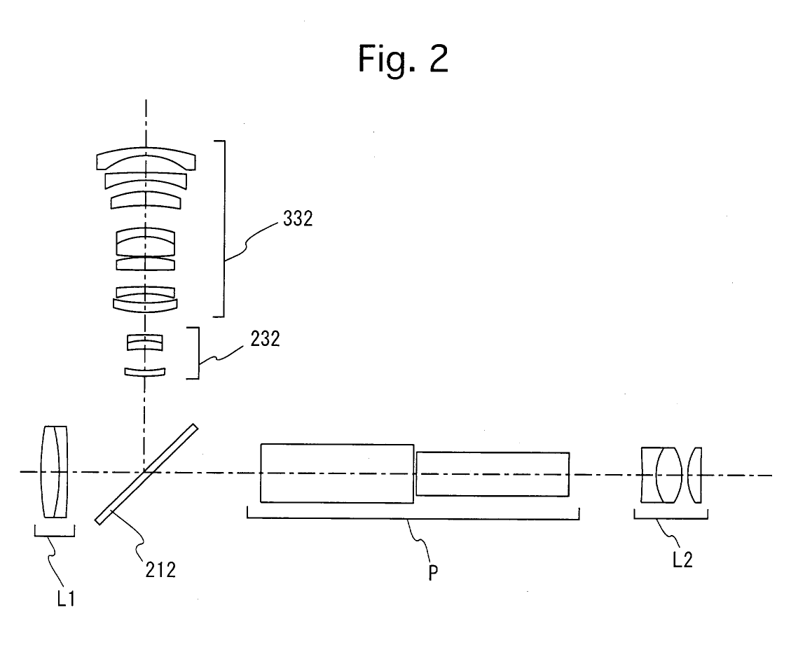

Although the negative lens 23 is made of a single lens element in the illustrated embodiment, it can be made of a plurality of lens elements. FIG. 2 shows a second embodiment of the present invention, in which the negative lens 23 is made of a plurality of lens elements and the photographing lens 332 is attached thereto. In the second embodiment shown in FIG. 2, a negative lens (optical element) 232 includes a negative meniscus lens and a cemented negative lens.

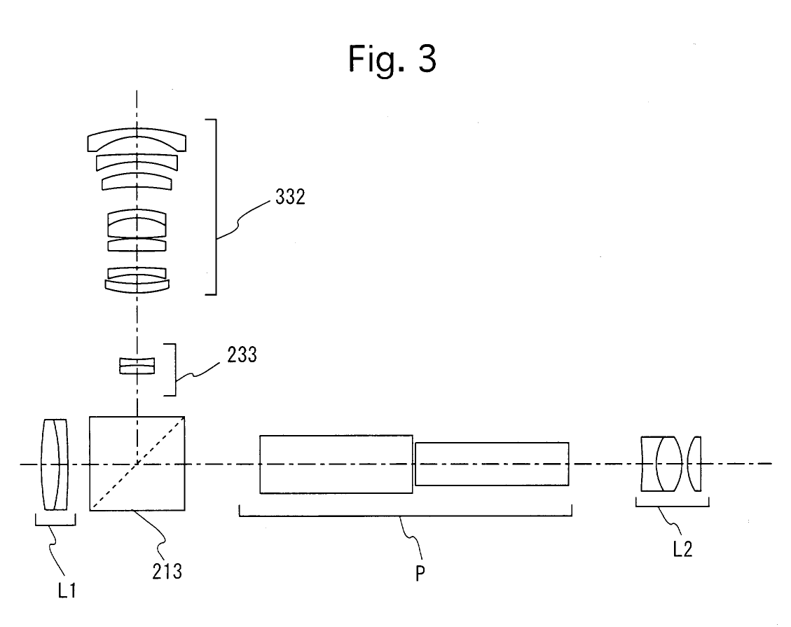

In the first and second embodiments, the stationary half mirror 21 or 212 is used as a beam splitter, however, the beam splitter in the present invention is not limited thereto. For example, a stationary prism 213 can be used as a beam splitter as in a third embodiment illustrated in FIG. 3.

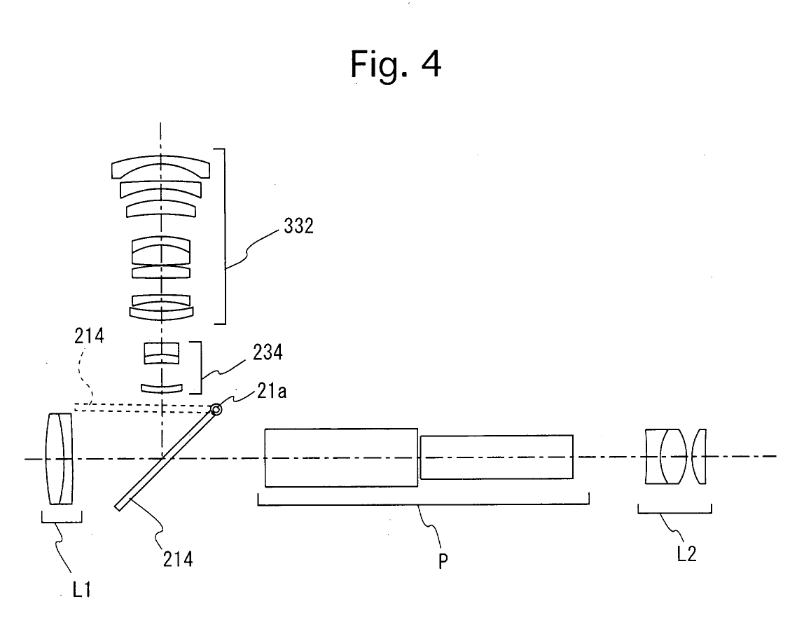

In a fourth embodiment shown in FIG. 4, a mirror driving mechanism is provided wherein a movable mirror 214 is rotatably connected at one end thereof to a pivot shaft 21a, so that when no camera is attached, the movable mirror 214 is moved to a retracted position indicated by a phantom line in which the movable mirror 214 is out of the light path of the objective lens group L1; when the camera is attached, the movable mirror 214 is moved to a photographing position, into the light path of the objective lens group L1. In this embodiment, the mirror portion of the movable mirror 214 is made of a total reflection mirror but can be made of a half mirror.

A negative lens (optical element) 233 in the third embodiment shown in FIG. 3 comprises a cemented negative lens. A negative lens (optical element) 234 in the fourth embodiment shown in FIG. 4 is constructed from a negative meniscus lens and a cemented negative lens.

When the present invention is applied to a binocular, the telescopes which constitute the binocular can be each made of the lens barrel which is constructed as shown in FIGS. 1, 2, 3 or 4. If the lens barrels are each provided with a photographing optical system attachment/detachment portion, the components and the manufacturing apparatus of the lens barrels can be common. A user can attach a camera to any one of the lens barrels or can attach cameras to both the lens barrels to provide a stereo photographing camera. Moreover, if a half mirror or a prism provided as a beam splitter is inserted in only one of the lens barrels, a plane-parallel plate whose optical thickness is identical to that of the half mirror or the prism is inserted in the lens barrel in which no beam splitter is inserted.

As mentioned above, when a user holds and uses the binocular of the present invention outdoors, the visual field of the binocular can be picked up by the electronic camera and displayed in the liquid crystal display. Therefore, even if the user is, for example, a child who is not familiar with the operation of the binocular, an instructor can easily check whether or not a target object is included in the field of view of the binocular by observing the image of the object displayed in the LCD. Thus, the object can be correctly located in the field of view of the binoculars by the user or the instructor can make an accurate explanation of the object to the user.

As can be seen from the above discussion, according to the present invention, in a viewing apparatus, a beam splitter is located closer to the object than the focal plane of the objective optical system, a negative lens is provided in the optical path of the light split by the beam splitter, and the photographing system attachment/detachment portion to which a photographing optical system is detachably attached is provided on the emission side of the negative lens. Accordingly, when an electronic camera such as a digital still camera in which a picked-up object image can be monitored is attached to the photographing optical system attachment/detachment portion, a third person can view the object image picked up by the electronic camera while a viewer views the object through the ocular optical system.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A viewing apparatus in which an object image formed by an objective optical system is viewed through an ocular optical system, comprising:
a beam splitting optical system which is located closer to an object than a focal plane of the objective optical system in a light path of the objective optical system;
a negative lens provided in an optical path of light split by the beam splitting optical system; and,
a photographing optical system attachment/detachment portion provided on a light emission side of the negative lens.

2. The viewing apparatus according to claim 1, wherein an electronic camera which can photograph said object image formed through the objective optical system and said negative lens is detachably attached at a front end of a photographing lens thereof to the photographing optical system attachment/detachment portion.

3. The viewing apparatus according to claim 1, wherein the focal length and the position of the negative lens provided in the optical path of the split light are determined so that the axial rays of light emitted from the negative lens substantially become one of parallel rays and divergent rays of light.

4. The viewing apparatus according to claim 1, wherein said beam splitting optical system comprises a half mirror.

5. The viewing apparatus according to claim 1, wherein said beam splitting optical system comprises a prism.

6. The viewing apparatus according to claim 1, wherein said beam splitting optical system comprises a stationary half mirror provided in the light path of the objective optical system.

7. The viewing apparatus according to claim 1, wherein said beam splitting optical system is movable between a retracted position out of the light path of the objective optical system and a photographing position in the light path of the objective optical system.

8. The viewing apparatus according to claim 1, wherein said beam splitting optical system comprises a total reflection mirror that is movable between a retracted position out of the light path of the objective optical system and a photographing position in the light path of the objective optical system.

9. A viewing apparatus in which an object image formed by an objective optical system is viewed through an ocular optical system, comprising:
a beam splitting optical system which is located closer to an object than a focal plane of the objective optical system in a light path of the objective optical system;
an optical element provided in an optical path of light split by the beam splitting optical system; and,
a photographing optical system attachment/detachment portion provided on a light emission side of the optical element;
wherein said optical element causes the axial rays of light emitted from said optical element to be one of substantially parallel rays and divergent rays.

10. The viewing apparatus according to claim 9, wherein said optical element comprises a single negative lens element.

11. The viewing apparatus according to claim 9, wherein said optical element comprises a plurality of lens elements and the photographing lens.

12. The viewing apparatus according to claim 9, wherein said negative lens comprises a negative meniscus lens and a cemented negative lens.

13. The viewing apparatus according to claim 8, wherein said negative lens comprises a cemented negative lens.
